(19) United States
(12) Patent Application Publication
(10) Pub. No.: US 2006/0095263 A1
(43) Pub. Date: May 4, 2006

(54) Character string input apparatus and method of controlling same

(76) Inventors: Katsuhiko Kawasaki, Kawasaki-shi (JP); Makoto Hirota, Shibuya-ku (JP)

Correspondence Address: MORGAN & FINNEGAN, L.L.P., 3 WORLD FINANCIAL CENTER, NEW YORK, NY, 10281-2101, US

(21) Appl. No.: 11/246,977

(22) Filed: Oct. 7, 2005

(30) Foreign Application Priority Data
Oct. 8, 2004 (JP) 2004-296691

(51) Int. Cl. G10L 15/18

(52) U.S. Cl. 704/257

(57) ABSTRACT

A character string input apparatus having specifying means for specifying a category of a character, and speech receiving means for receiving speech, wherein a character string is input based upon a specifying input from the specifying means and speech that has been received by the speech receiving means, is provided. Obtaining means obtains a plurality of character strings based-upon a series of specifying inputs by the specifying means. Generating means which, on the basis of the plurality of character strings obtained by the obtaining means, generates speech recognition grammar with respect to speech received by the speech receiving means following the series of specifying inputs. Speech recognition means performs speech recognition, using the speech recognition grammar generated by the generating means, with respect to the speech received by the speech receiving means following the series of specifying inputs.

### FIELD OF THE INVENTION

This invention relates to a character string input apparatus and to a method of controlling the same. More particularly, the invention relates to a character string input apparatus for inputting a character string using a key operation and speech input in combination.

### BACKGROUND OF THE INVENTION

The diversification of information-related devices is progressing in the form of mobile telephones, PDAs, car navigation systems, digital televisions and facsimile machines. Many of these devices come equipped with a communication function such as a function for connecting to the Internet. There are more and more cases where such devices are utilized as means for exchanging textual information such as through use of e-mail and the World-Wide Web.

Such devices usually do not possess a keyboard and difficulty is encountered when inputting text. Mobile telephones and facsimile machines usually have a numeric keypad and entry of text by operating such keypads is widespread.

Such input schemes have been improved in various ways. One example is a predictive input method in which when the first few characters are input, the ensuing character string is predicted and presented. A method in which input of text is made possible by inputting only consonants also has been devised.

Speech input techniques have become the focus of attention as a substitute for inconvenient key operation. IBM's ViaVoice, for example, is available as a method of inputting any text by speech input. Methods that combine key input and speech input also exist. For example, the specifications of Japanese Patent Application Laid-Open Nos. 2000-056796 and 9-288495 disclose techniques that make it possible to input text by performing a speech input at the same time as a key input.

In the prior art, the method that relies solely upon key input has been made more convenient by such improvements as the predictive capability and consonant input. Nevertheless, many problems still remain. If the predicting accuracy of the predictive function is poor, the advantage gained by this conventional method is diminished. Further, with the consonant input method, there are many character-string candidates that correspond to a consonant string and the operation of making a selection from among these candidates lowers overall efficiency.

On the other hand, a method such as ViaVQice that relies upon speech recognition generally requires a great deal of memory and CPU power. At the present time, therefore, it is difficult to achieve such input in a small-size device such as a mobile telephone or facsimile machine.

The methods of performing a speech input at the same time as a key input set forth in the above-mentioned Japanese Patent Application Laid-Open Nos. 2000-056796 and 9-288495 have the potential to serve as effective means of ameliorating the above-described problems encountered in the prior art. However, both disclosures are premised on the fact that input speech corresponding to a key input is clearly distinguished with regard to each depression of an individual key. For example, these disclosures are premised on the fact that in a case where the letters of the alphabet “A” and “D” are uttered while the keys “2” and “3” are pressed, the sound of “A” corresponding to depression of key “2” and the sound of “D” corresponding to depression of key “3” are distinguished from each other beforehand by some method. One method of making this possible is to provide a sufficiently long time interval between depression of the key “2” and depression of the key “3” and utter “A” and “D” with a pause between these utterances that conforms to this time interval. With this approach, however, the efficiency of text input declines and so does the naturalness of operation.

In order to enhance the efficiency and naturalness of operation, therefore, it is necessary to make it possible to press the keys “2” and “3” in quick succession and utter “AD” in quick succession without a pause.

### SUMMARY OF THE INVENTION

In view of the problems of the prior art, the object of the present invention is to improve the operating efficiency and naturalness of character string input in a character string input apparatus for inputting a character string using key operation and speech input in combination.

In one aspect of the present invention, a character string input apparatus having specifying means for specifying a category of a character, and speech receiving means for receiving speech, wherein a character string is input based upon a specifying input from the specifying means and speech that has been received by the speech receiving means, is provided. Obtaining means obtains a plurality of character strings based upon a series of specifying inputs by the specifying means. Generating means which, on the basis of the plurality of character strings obtained by the obtaining means, generates speech recognition grammar with respect to speech received by the speech receiving means following the series of specifying inputs. Speech recognition means performs speech recognition, using the speech recognition grammar generated by the generating means, with respect to the speech received by the speech receiving means following the series of specifying inputs.

The above and other objects and features of the present invention will appear more fully hereinafter from a consideration of the following description taken in connection with the accompanying drawing wherein one example is illustrated by way of example.

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a diagram illustrating the external arrangement of a facsimile apparatus according to an embodiment of the present invention;

FIG. 2 is a diagram illustrating the hardware implementation of the facsimile apparatus according to the embodiment of the present invention;

FIG. 3 is a block diagram illustrating a functional implementation regarding text input from a facsimile apparatus according to the embodiment of the present invention;

FIG. 4 is a diagram illustrating an example of information appended to each character;

FIG. 5 is a diagram illustrating an example of character-concatenation cost data;

FIG. 6 is a diagram illustrating an example of a lattice structure generated in accordance with pressed keys;

FIG. 7 is a diagram illustrating an example of speech recognition grammar; and

FIG. 8 is a flowchart for describing operation of a facsimile apparatus according to the embodiment of the present invention.

### DETAILED DESCRIPTION OF THE PREFERRED EMBODIMENTS

Preferred embodiment(s) of the present invention will be described in detail in accordance with the accompanying drawings. The present invention is not limited by the disclosure of the embodiments and all combinations of the features described in the embodiments are not always indispensable to solving means of the present invention.

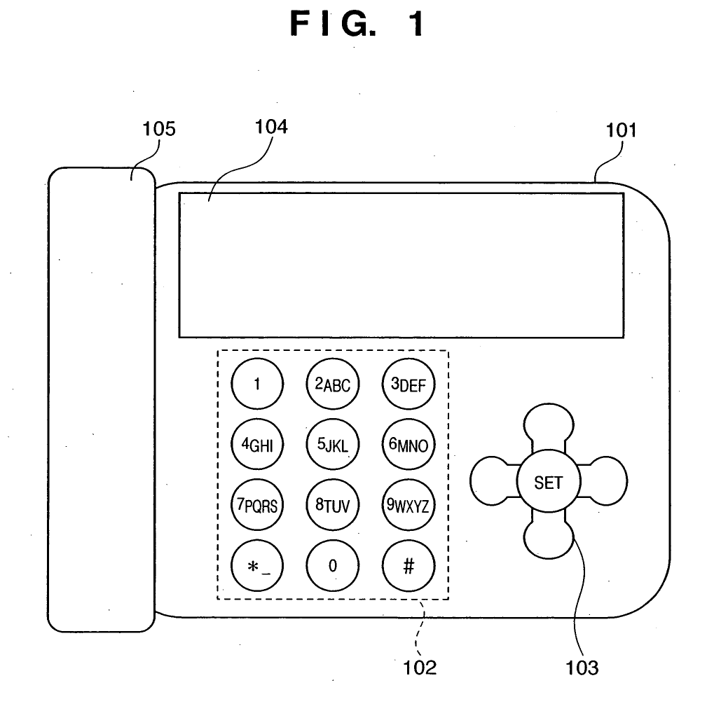

FIG. 1 is a diagram illustrating the external arrangement of a facsimile apparatus 101 according to an embodiment of the present invention.

As shown in FIG. 1, the facsimile apparatus 101 has a numeric keypad 102, a so-called “arrow key” 103, which comprises keys for movement up, down, left and right, and a centrally located “SET” key, a liquid crystal screen 104, and a telephone handset 105 via which speech is input.

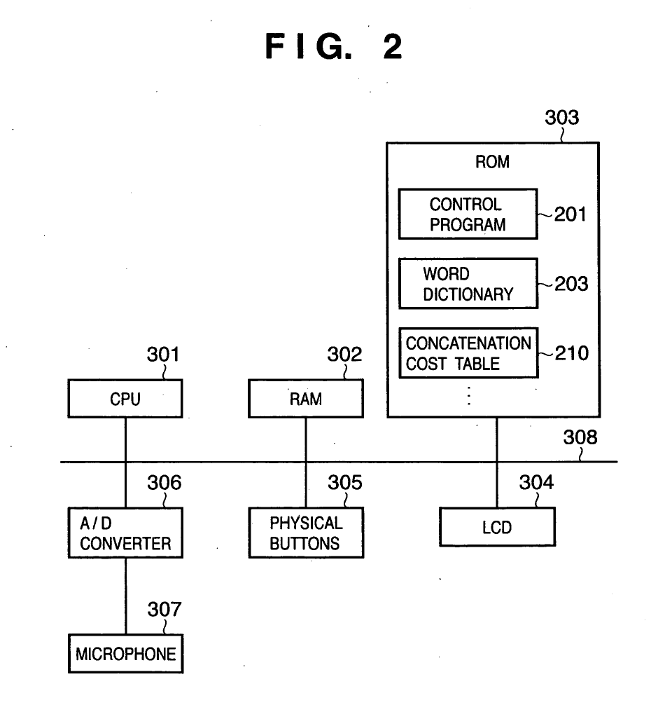

FIG. 2 is a diagram illustrating the hardware implementation of the facsimile apparatus 101 according to this embodiment.

The apparatus includes a CPU 301 that operates in accordance with a program for implementing the operating procedure of the facsimile apparatus 101, described later; a RAM 302, which serves as a main memory, provides a storage area necessary for operation of the CPU 301; a ROM 303 that holds a control program for implementing the operating procedure according to the present invention, a word dictionary 203 and a concatenation cost table 210; an LCD (liquid crystal display) 304, which corresponds to the liquid crystal screen 104 of FIG. 1; physical buttons 305, which include the numeric keypad 102 and arrow key 103; an A/D converter 306 for converting input speech to a digital signal; a microphone 307 constituting the handset 105; and a bus 308.

The specific operation of the facsimile apparatus 101 according to this embodiment will now be described.

First, each character string that is to be input is classified into nine categories, for example, and each category is assigned to a key of the numeric keypad 102 in the manner indicated below. That is, the numeric keypad 102 functions as specifying means that specifies the category of a character. The assignments are as follows:

| | |
|---|---|
| “1” | blank (space) |
| “2” | “A” “B” “C” |
| “3” | “D” “E” “F” |
| “4” | “G” “H” “I” |
| “5” | “J” “K” “L” |
| “6” | “M” “N” “O” |
| “7” | “P” “Q” “R” “S” |
| “8” | “T” “U” “V” |
| “9” | “W” “X” “Y” “Z” |

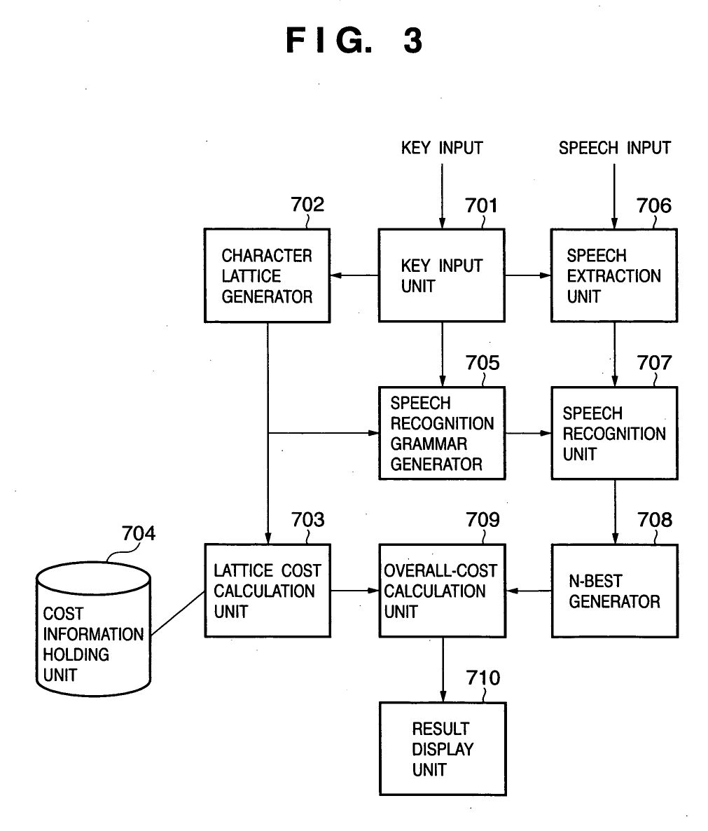

FIG. 3 is a block diagram illustrating a functional implementation regarding text input from a facsimile apparatus according to this embodiment.

In FIG. 3, a key input unit 701 accepts key inputs from the numeric keypad 102 and arrow key 103, and a character lattice generator 702 generates a character-string lattice that conforms to the key input sequence. A cost information holding unit 704 holds information concerning character cost and character-concatenation cost. A lattice cost calculation unit 703 calculates the lattice cost of a character-string lattice from the cost information.

A speech extraction unit 706 extracts input speech, which is for text input, from a speech signal that enters from the handset 105. The input speech is extracted as speech data that has been recorded from prolonged key depression to release of the key from prolonged depression. A speech recognition grammar generator 705 generates speech recognition grammar from the character lattice. A speech recognition unit 707 performs speech recognition based upon the speech recognition grammar. An N-best generator 708 arranges results of speech recognition in order of score. An overall-cost calculation unit 709 calculates overall cost from lattice cost and speech recognition score (speech cost). A result display unit 710 displays input candidates in order of overall cost.

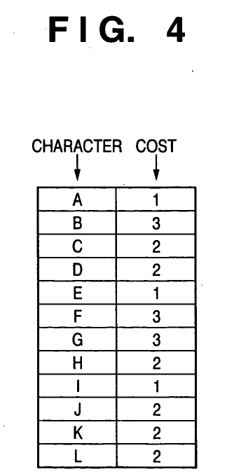

FIG. 4 is a diagram illustrating an example of information appended to each character. As illustrated in FIG. 4, a character cost is appended to each character. The character costs are held in the cost information holding unit 704 in such a structure. Character cost is data that takes on a value; the higher the frequency of occurrence of the character, the lower the value.

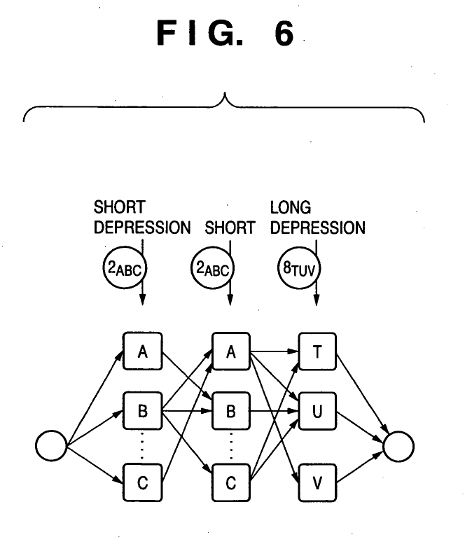

FIG. 6 illustrates an example of a lattice structure that is generated when “2”, “2”, “8” are input by pressing keys. With respect to the lattice of FIG. 6 that corresponds to the numeric keypad input string “2”, “2”, “8”, the lattice cost calculation unit 703 calculates language cost NA of each path in accordance with the following equation:
NA=Σi[C(Ni)+C(Ni−1,Ni)]
where C(Ni) and C(Ni−1,Ni) represent the following:
C(Ni): character cost of character Ni
C(Ni−1, Ni): character concatenation cost of Ni−1 and Ni

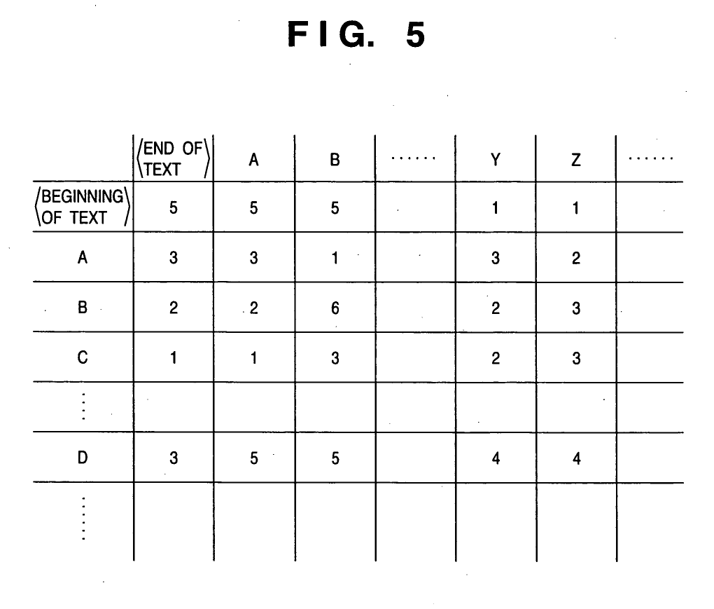

The character concatenation cost is a numerical value that indicates the degree of difficulty of concatenating one character and another. The character concatenation cost is held by the cost information holding unit 704 as data of the kind shown in FIG. 5.

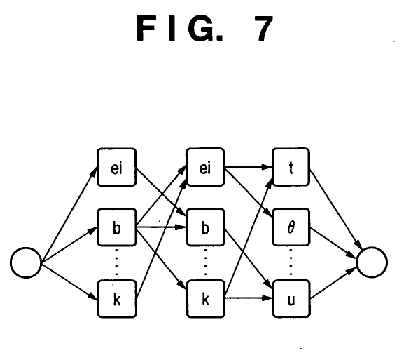

Next, speech recognition grammar of the kind shown in FIG. 7 is generated from the character-string lattice of FIG. 6. The speech recognition grammar comprises pronunciation symbols capable of being produced from a string of characters. For example, “k” and “ky”, etc., are examples of pronunciation symbols regarding character “C”, and “ei” and “a”, etc., are examples of pronunciation symbols regarding character “A”. The N-best generator 708 calculates speech cost NB of each path using the speech recognition grammar of FIG. 7.
NB(“kyaQt)=0.82,
NB(“akt”)=0.51,

The overall-cost calculation unit 709 calculates the overall cost NE of each path in accordance with the following equation:
NE=NA−NB

The control panel 710 displays input candidates in order of increasing overall cost NE.

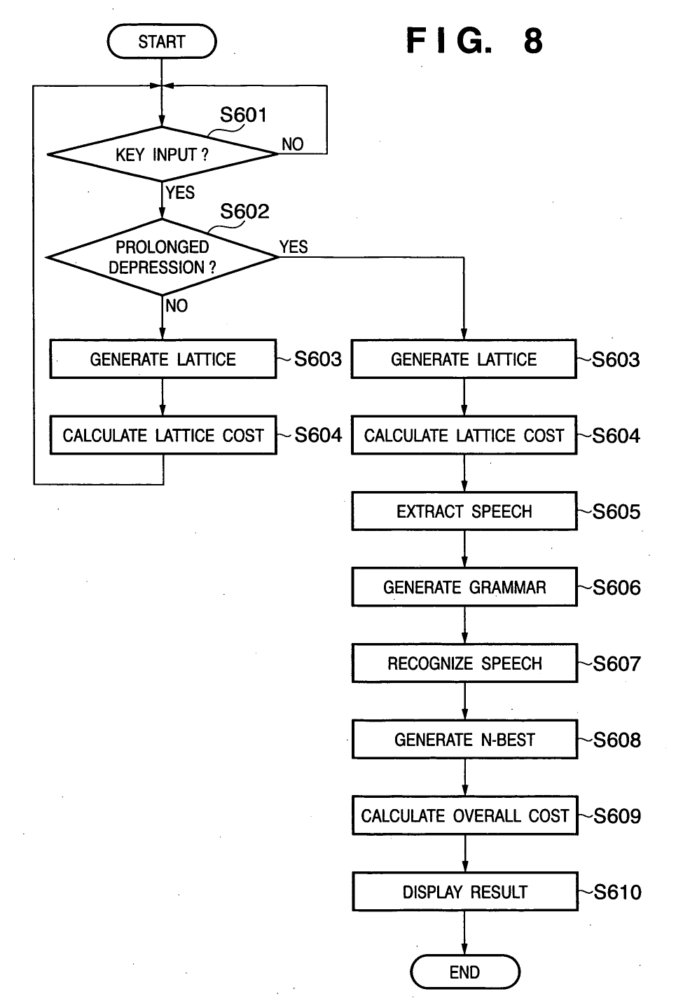

FIG. 8 is a flowchart for describing operation of a facsimile apparatus according to the embodiment of the present invention.

First, at step S601, the apparatus waits for an input from the numeric keypad. If there is an input from the numeric keypad, then control proceeds to step S602, where it is determined whether the depression of the key is prolonged. If depression of the key is short (“NO” at step S602), then a character-string lattice of the kind shown in FIG. 6 is generated at step S603. This is followed by step S604, at which the lattice cost of each path is calculated using character cost of the kind shown in FIG. 4 and character-concatenation cost of the kind shown in FIG. 5.

On the other hand, if it is determined at step S602 that depression of the key is prolonged, then, after execution of the aforesaid steps S603, S604 in similar fashion, control proceeds to step S605, where the user is prompted to make an utterance and, in addition, the utterance of the user is recorded during depression of the key and a speech interval is extracted.

Speech recognition grammar is generated at step S606, speech recognition is performed at step S607 using the speech recognition grammar, and speech cost of each path is calculated and N-best generated at step S608. Overall cost is then calculated from the lattice cost and speech cost at step S609, and candidates are displayed on the display screen in order of increasing overall cost at step S610. In response, the user selects the desired candidate from among the candidates displayed.

Adopting this arrangement improves operating efficiency in a case where characters are input making combined use of a key input operation and speech input. More specifically, the effects obtained include a decrease in number of key operations when text is input by operating keys, as well as a speech-input capability even with a device having limited resources.

In the embodiment set forth above, speech recognition grammar comprising pronunciation symbols capable of being produced from a string of characters is generated from a character-string lattice. However, it may be so arranged that an appropriate string of characters in the form of a word is generated as recognition grammar using a word dictionary.

Further, in the embodiment set forth above, the extraction of a speech interval and the ensuing generation of speech recognition grammar and speech recognition are performed using prolonged depression of a key at the trigger. However, in an alternative arrangement, it is permissible to provide a “SPEAK” button and perform the extraction of a speech interval and the ensuing generation of speech recognition grammar and speech recognition using depression of the “SPEAK” button after input of a series of numeric-key sequences as the trigger.

Further, in the embodiment set forth above, cost is calculated using word cost and word-to-word concatenation cost, etc. However, if plausibility as a word can be evaluated with regard to a word string, then another evaluation criterion may be used. For example, part-of-speech information may be appended to each word of a word dictionary and cost of concatenation between parts of speech may be used instead of cost of concatenation between words. Further, the appended information is not limited to part of speech; words may be classified into certain classes, this class information may be appended to each word in a word dictionary and class-to-class concatenation cost may be used instead of word-to-word concatenation cost.

Furthermore, the present invention is not limited to a specific cost calculation equation for path selection used in the above-described embodiment. If word cost, word-to-word concatenation cost (or cost of concatenation between parts of speech or class-to-class concatenation cost) and speech recognition grammar are suitably reflected, other calculation equations may be used.

Further, assignment of characters to numeric keys is not limited to the assignment described in the foregoing embodiment; any assignment may be performed.

Further, a facsimile apparatus is dealt with as the device of interest in the foregoing embodiment. However, it goes without saying that the present invention is applicable to any device having a speech input function and a graphical user interface or operating buttons.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2004-296691 filed on Oct. 8, 2004, the entire contents of which are hereby incorporated by reference herein.

What is claimed is:

1. A character string input apparatus having specifying means for specifying a category of a character, and speech receiving means for receiving speech, said apparatus inputting a character string based upon a specifying input by the specifying means and speech that has been received by said speech receiving means, said apparatus comprising:
obtaining means for obtaining a plurality of character strings based upon a series of specifying inputs by said specifying means;
generating means which, on the basis of the plurality of character strings obtained by said obtaining means, is for generating speech recognition grammar with respect to speech received by said speech receiving means following the series of specifying inputs;
speech recognition means for performing speech recognition, using the speech recognition grammar generated by said generating means, with respect to the speech received by said speech receiving means following the series of specifying inputs;

2. The apparatus according to claim 1, wherein said obtaining means obtains the plurality of character strings and a lattice cost of each character string; and further comprising,
character-string candidate generating means which, with regard to each character string obtained by said obtaining means, is for calculating likelihood that takes into consideration a speech recognition score obtained in the course of speech recognition by said speech recognition means and the lattice cost obtained by said obtaining means, and generating character-string candidates based upon this likelihood;
display control means for controlling displaying the character-string candidates generated by said character-string candidate generating means.

3. The apparatus according to claim 2, wherein said obtaining means obtains the lattice cost based on the character cost which is associated with the frequency of occurrence of the character.

4. The apparatus according to claim 2, wherein said obtaining means obtains the lattice cost based on the character concatenation cost which is a value that indicates the degree of difficulty of concatenating one character and another.

5. The apparatus according to claim 1, further comprising a word dictionary constructed so that it can be searched based upon a specifying input by said specifying means;
wherein said obtaining means retrieves a word, which corresponds to the series of specifying inputs, from said word dictionary and obtains the plurality character strings from the retrieved word.

6. A method for controlling a character string input apparatus having specifying means for specifying a category of a character, and speech receiving means for receiving speech, the apparatus inputting a character string based upon a specifying input by the specifying means and speech that has been received by the speech receiving means, said method comprising the steps of:
(a) accepting a series of specifying inputs by the specifying means;
(b) obtaining a plurality of character strings based upon the series of specifying inputs;
(c) receiving speech by the speech receiving means following the series of specifying inputs;
(d) generating speech recognition grammar with respect to speech received at said step (c) on the basis of the plurality of character strings obtained at said step (b);
(e) performing speech recognition, using the speech recognition grammar generated at said step (d), with respect to the speech that has been received at said step (c);

7. A program for implementing a method of controlling the character string input apparatus set forth in claim 6.
